(19) United States
(12) Patent Application Publication
(10) Pub. No.: US 2010/0294746 A1
(43) Pub. Date: Nov. 25, 2010

(54) LASER SCRIBING PLATFORM WITH MOVING GANTRY

(75) Inventors: Robert Bann, Banbury (GB); Clive Alexander, Northhampton (GB); Duncan Thomas Bee, Warrington (GB); Graeme Elliner, Brackley Northants (GB); Neil Sykes, Santa Clara, CA (US); Nicolas Mantel, Santa Clara, CA (US); Philipp Grunewald, (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/622,303

(22) Filed: Nov. 19, 2009

Related U.S. Application Data
(60) Provisional application No. 61/116,247, filed on Nov. 19, 2008.

(51) Int. Cl. B23K 26/00

(52) U.S. Cl. 219/121.69; 219/121.68

(57) ABSTRACT

Laser scribing can be performed on a workpiece such as a substrate with layers formed thereon for use in a solar cell without need to move the workpiece during the scribing process. A series of lasers can be used to concurrently remove material from multiple positions on the workpiece. These laser outputs are directed to the workpiece using an optical system partially attached to a gantry. The gantry can be moved longitudinally and the portion of the optical system attached to the gantry can be moved laterally so that the combined outputs of all lasers can be directed to substantially any position on the workpiece without moving the workpiece.

### CROSS-REFERENCES TO RELATED APPLICATIONS

This application claims the benefit of U.S. Provisional Application No. 61/116,247, filed on Nov. 19, 2008, entitled “Laser Scribing Platform with Moving Gantry,” the entire disclosure of which is hereby incorporated herein by reference.

### BACKGROUND

Various embodiments described herein relate generally to the scribing of materials, as well as methods and apparatus for scribing the materials. These methods and apparatus can be particularly effective in scribing thin film multi junction solar cells.

Current methods for forming thin film solar cells involve depositing or otherwise forming a plurality of layers on a substrate, such as a glass, metal or polymer substrate suitable to form one or more p-n junctions. An example of a solar cell is shown in FIG. 1. This example of a solar cell has an oxide layer 120 (e.g., a transparent conductive oxide (TCO)) deposited on a substrate 110, followed by an amorphous silicon layer 130 and a metal back layer 140. Examples of materials that can be used to form solar cells, along with methods and apparatus for forming the cells, are described, for example, in U.S. Pat. No. 7,582,515, entitled “MULTI-JUNCTION SOLAR CELLS AND METHODS AND APPARATUSES FOR FORMING THE SAME,” which is hereby incorporated herein by reference. When a panel is being formed from a large substrate, a series of scribe lines is typically used within each layer to delineate the individual cells.

These laser scribed lines are formed on a workpiece, which consists of a substrate and deposited layers, by removing material from the deposited layers. This removal or ablation is achieved by concentrating a large amount of energy into a very short duration laser pulse and choosing the optimal laser wavelength to couple with the material to be removed. When the correct conditions for ablation are achieved, the material is removed in an explosive plume that contains debris. Debris from the laser scribing process is normally removed using an extraction unit. In FIG. 1, these scribe lines are P1 (formed by removing material from the TCO layer), P2 (formed by removing material from the amorphous silicon layer), and P3 (formed by removing material from the amorphous silicon layer and the metal back layer).

In previous approaches, generation of these scribe lines involved moving a substrate relative to at least one laser. If the solar cells included scribe lines in multiple directions on the panel, such as both longitudinal and latitudinal scribe lines, then it was necessary to rotate the substrate with respect to the lasers. Moving and rotating the substrate made it difficult to align the scribing laser beam output on the substrate. Acceleration and deceleration of the substrate significantly reduced the accuracy of these laser alignments. There is a need to improve the accuracy of these laser alignments.

In order to reduce cost and produce larger solar cell panels, manufacturers have progressed to using larger size glass substrate as the starting material for these solar panels. While using these larger size glass substrates has clear economical and functional benefits, their use has also spawned new technical challenges related to the handling, aligning, and processing of larger size substrates. For example, a larger size glass substrate will be harder to handle, because of its larger size and because it will tend to sag or bow down more near the edge due to weight.

A larger size glass substrate will also have a greater variation in substrate thickness, making it more difficult to keep the scribing laser beam output focused at the point where the laser scribing occurs. The scribing laser beam enters the workpiece from the glass substrate side, penetrating the glass substrate and exiting through the deposited layers side. The scribing process occurs at the deposited layers side, so the deposited layers side of a thinner substrate will be closer to the laser source, requiring a shorter focusing distance than a thicker substrate. Similarly, if there is sagging or bowing down of the glass substrate near the edge due to weight, then a shorter focusing distance will also be required.

Laser alignment within a tight tolerance on a large size substrate is made more difficult, because of the larger substrate size. However, a tight tolerance between the P1 scribe lines (i.e., TCO layer scribe lines) and the P3 scribe lines (i.e., the metal back layer scribe lines) will yield tremendous benefits, because the regions lying between the P1 and P3 scribe lines constitute non-active solar cell area (i.e., the dead zone). In order to optimize the efficiency of these solar cell panels, the non-active solar cell area (i.e., the dead zone) of these panels should be minimized. To minimize the dead zone, the P3 line should be aligned as close as possible to the P1 line. In previous approaches, it was hard to minimize this gap between the P1 and P3 lines in the scribe pattern due to the huge area of solar panel. Slight temperature changes would cause distortion or expansion of the panel or the laser scribing system itself. Stage and mirror optics calibration noise, uncorrected mean errors, process induced geometrical distortions, material property inhomogeneities, and material thickness variations also contribute error to the scribing process. Therefore the scribe pattern had to be defined with a P1 and P3 gap that includes all the tolerances due to thermal or mechanical factors. The result was a large gap, a large dead zone, and consequently reduced solar panel efficiency. Further, there was also a need for frequent calibration due to long term thermal drift of the optical system directing the laser beam output to the workpiece. Even further still, to improve the alignment between two scribe lines, the straightness of both lines (e.g., P1 and P3 lines) had to be maintained.

During the laser scribing process, a bed or stage is typically used to hold a workpiece. A larger size glass substrate will require a larger size stage. Therefore, there is a need to minimize the size of this stage and to design it for easier shipment, installation, and reassembly. In particular, there is a need to design the stage so it can be shipped using conventional transport methods.

Accordingly, it is desirable to develop systems and methods that overcome at least some of these, as well as potentially other, deficiencies in existing scribing and solar panel manufacturing devices.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some aspects and embodiments in a simplified form as a prelude to the more detailed description that is presented later.

Systems and methods are provided for laser scribing a workpiece. The workpiece can be a large film-deposited substrates used to fabricate solar cells. In many embodiments, the disclosed systems and methods employ a gantry that moves in a longitudinal direction relative to a supported workpiece. At least one scanning device operable to control a position of an output from at least one scribing laser can be mounted to the gantry, and can be translatable in a lateral direction relative to the supported workpiece. Various embodiments may provide for improved control of scribe line positions, as well as the ability to scribe in multiple directions without moving the workpiece. For example, the combination of a longitudinally moving gantry, at least one scanning device mounted to the gantry for lateral movement, and the ability of the at least one scanning device to control a position of an output from the at least one laser can be employed to scribe substantially any pattern on a workpiece without moving the workpiece.

Thus, in a first aspect, a system for scribing a workpiece is provided. The system includes a stationary stage operable to support the workpiece, a laser generating output able to remove material from at least a portion of the workpiece, and a translatable scanning device operable to control a position of the output from the laser. Substantially any pattern can be scribed on the workpiece without moving the workpiece.

In many embodiments, the translatable scanning device includes a optical system, and at least a portion of the optical system is held by a gantry. The optical system is operable to direct output from the laser to the workpiece. In many embodiments, the gantry is translatable longitudinally and the portion of the optical system mounted to the gantry is translatable laterally, such that output from a laser is able to be directed to substantially any position on the workpiece without moving the workpiece. In many embodiments, the gantry is further operable to direct additional laser outputs laterally in order to control positions of the laser outputs relative to the workpiece, such that the output from each laser is able to reach a portion of the workpiece. And the combined output from all the lasers is able to reach substantially any position on the workpiece.

In many embodiments, the system is used to scribe a workpiece used for forming a solar cell. For example, the workpiece can include a substrate and at least one layer used for forming a solar cell. And the laser is able to remove material from the at least one layer.

In many embodiments, the stationary stage includes air bearings to support the workpiece. The air bearings can be configured to allow the laser generating output to remain focused at the point where the laser generating output removes material from at least a portion of the workpiece. The laser output can be directed at the workpiece from the side of the workpiece that is facing the stationary stage.

In many embodiments, the stationary stage includes movable support rollers operable to load and unload the workpiece. For example, the movable support rollers can collapse and expand to allow the laser output to reach the workpiece during the scribing process.

In many embodiments, the system can be disassembled for ease of shipment. For example, the system can be constructed from three parts that can be disassembled, packed in an International Organization for Standardization (ISO) container, and reassembled on site.

In another aspect, a method for scribing a workpiece is provided. The method includes directing output from a laser toward a workpiece, controlling a latitudinal position of the laser output relative to the workpiece by using optical elements on a gantry, and controlling a longitudinal position of the laser output relative to the workpiece by moving the gantry in order to scribe a determined pattern in at least a portion of the workpiece without moving the workpiece. A computer program product embedded in a computer-readable medium can include instructions for performing the method.

In another aspect, a system for aligning a laser for scribing a workpiece is provided. The system includes a laser operable to generate output able to remove material from at least a portion of the workpiece to form at least one feature on the workpiece, a scanning device operable to control a position of the output from the laser relative to the workpiece, and an imaging device operable to image previously-formed features on the workpiece. The scanning device is able to use image information from the imaging device to align the position of the output from the laser relative to at least one previously-formed features on the workpiece. In many embodiments, the at least one previously-formed feature on the workpiece is a laser scribed line.

In many embodiments, the system is used to scribe a workpiece used for forming a solar cell. For example, the workpiece can include a substrate and at least one layer used for forming a solar cell. And the laser is able to remove material from the at least one layer.

In many embodiments, the imaging device is able to align the position of the output from the laser relative to the at least one previously-formed feature on the workpiece by optically observing the previously-formed feature on the workpiece. The imaging device can be a camera. And the camera can be mounted between the laser and the scanning device so that the center of the camera view and the output of the laser point at substantially the same position on the workpiece. The imaging device can be included within the scanning device.

For a fuller understanding of the nature and advantages of the present invention, reference should be made to the ensuing detailed description and the accompanying drawings. Other aspects, objects and advantages of the invention will be apparent from the drawings and the detailed description that follows.

### BRIEF DESCRIPTION OF THE DRAWINGS

Various embodiments in accordance with the present invention will be described with reference to the drawings, in which:

FIG. 1 illustrates layers of a solar cell with scribe lines that can be formed in accordance with many embodiments;

FIG. 2 illustrates a perspective view of a laser scribing device including a movable gantry that can be used in accordance with many embodiments;

FIG. 3 illustrates an end view of a laser scribing device including part of an optical system, a debris extraction unit, and air bearings in accordance with many embodiments;

FIG. 4 illustrates scribe lines that can be formed from overlapping spots created through laser ablation in accordance with many embodiments;

FIG. 5 illustrates a control system for a laser scribing device that can be used in accordance with many embodiments;

FIG. 6 illustrates a longitudinal scan technique that can be used in accordance with many embodiments; and

FIG. 7 illustrates a latitudinal scan technique that can be used in accordance with many embodiments.

### DETAILED DESCRIPTION

Systems and methods in accordance with various embodiments of the present disclosure can overcome one or more of the aforementioned and other deficiencies in existing scribing and patterning approaches. Various embodiments can provide for improved control, as well as the ability to scribe in multiple directions without rotating the substrate. Devices in accordance with various embodiments provide for laser scribing on large film deposited substrates using at least one laser whose output is directed to the workpiece via a scanning device, which includes an optical system operable to direct output from the laser to the workpiece and a movable gantry holding at least a portion of the optical system. The gantry can be moved longitudinally and the portion of the optical system attached the gantry can be moved laterally. The scanning device is operable to control the position of the output from the laser so that substantially any pattern can be scribed on the workpiece without a need to rotate the workpiece. Further, while the embodiments are described with respect to scribing, it should be understood by one of ordinary skill in the art in view of the present specification that other patterning and manufacturing techniques can advantageously utilize various aspects described and suggested herein.

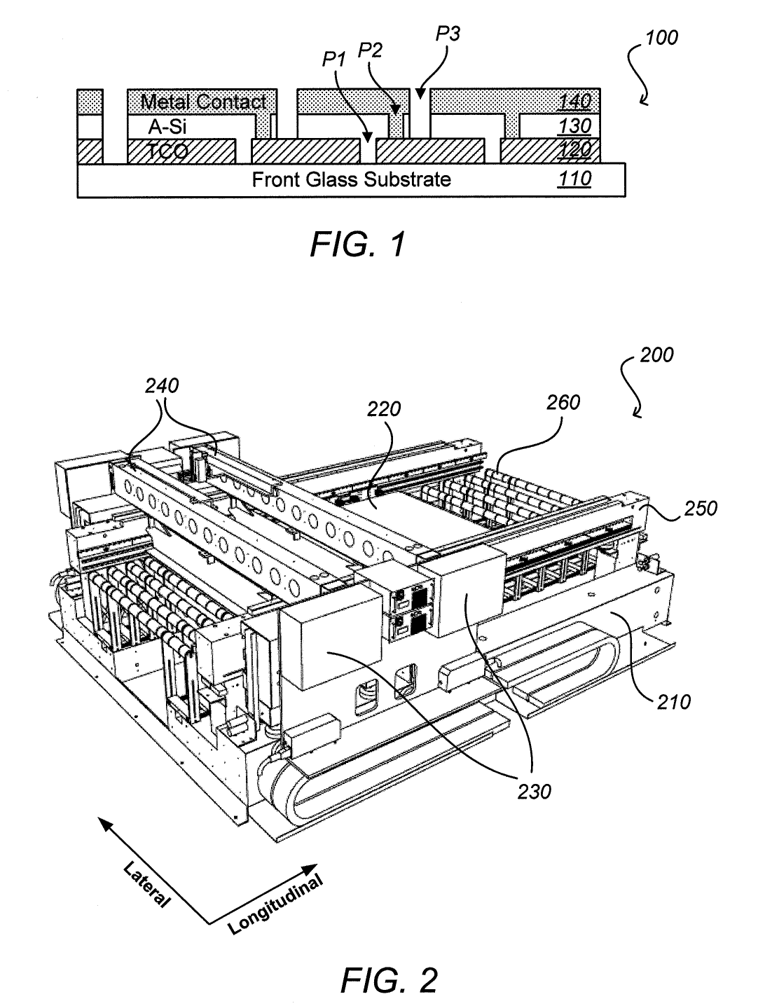

In the case of thin film solar cell panels, a number of different scribe lines can be used in different layers to provide for proper isolation between layer regions of different cells. FIG. 1 illustrates an example structure 100 of a set of thin film solar cells that can be formed in accordance with many embodiments. In this example, a glass substrate 110 has deposited thereon a layer of a transparent conductive oxide (TCO) 120, which then has scribed therein a pattern of first scribe lines (e.g., scribe 1 lines or P1 lines). A layer of amorphous silicon 130 is then deposited, and a pattern of second scribe lines (e.g., scribe 2 lines or P2 lines) formed therein. A metal back layer 140 then is deposited, and a pattern of third scribe lines (e.g., scribe 3 lines or P3 lines) formed therein. The area between adjacent P1 and P3 (including P2 therebetween) lines is a non-active area, or dead zone, which is desired to be minimized in order to improve efficiency of the overall array. Accordingly, it is desirable to control the spot size and positioning during the scribing process.

FIG. 2 illustrates an example of a laser scribing device 200 that can be used in accordance with many embodiments. The device includes a substantially planar bed or stage 210, which will be stationary. This planar stage will typically be leveled, for receiving, supporting, and holding a workpiece 220, such as a substrate having at least one layer deposited thereon. In one example, a workpiece is held stationary during the laser scribing process, while in another example the workpiece can be moved continually. This results in better accuracy of the scribing laser alignment, because the workpiece is not being constantly accelerated or decelerated. Typically, the workpiece will be aligned to a fixed orientation with the long axis of the workpiece substantially parallel to a longitudinal direction of the workpiece in the device, for reasons described elsewhere herein. The alignment can be aided by the use of cameras or imaging devices that acquire marks on the workpiece.

In this example, the scribing lasers 230 are positioned to the side of the planar stage 210, and the laser output is directed onto the workpiece 220 using an optical system that may include optical elements such as mirrors, beam splitters, lens, etc. At least part of the optical system is attached to a movable gantry 240. The movable gantry 240, which holds a portion of the optical system, can be moved in a longitudinal direction, while the portion of the optical system on the gantry can be moved laterally. This enables the output from the laser to be directed to substantially any position on the workpiece without moving the workpiece. As the gantry 240 is translated longitudinally back and forth on the stage 210 via a rail device 250, a scribing area of the laser assembly effectively scribes from near an edge region of the substrate to near an opposite edge region of the substrate. While a simple gantry assembly is shown, it should be apparent to one of ordinary skill in the art that any of a number of appropriate gantry-type assemblies can be used to translate the gantry longitudinally with respect to the workpiece. In order to ensure that the scribe lines are being formed properly, an imaging device, microscope, profiler, or similar device can image at least one of the lines after scribing. The stage 210 and the movable gantry 240 can be made out of at least one appropriate material, such as granite.

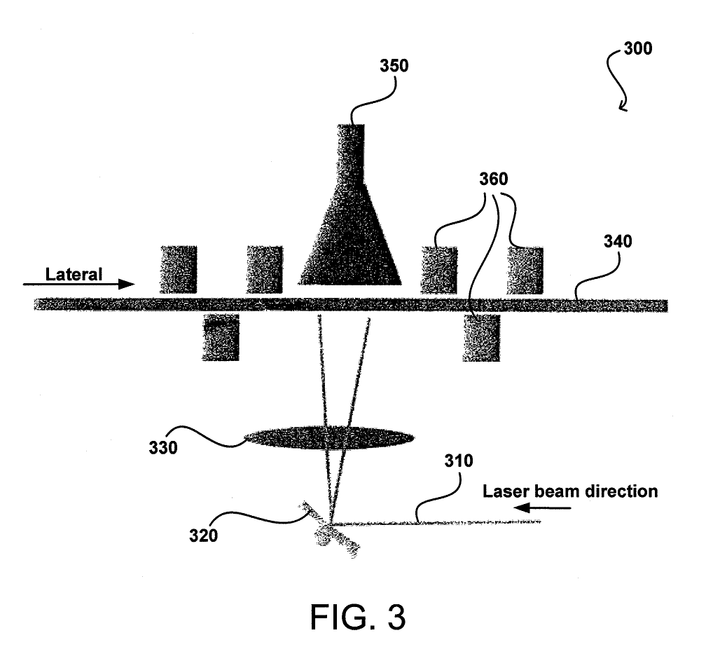

The workpiece 220 is typically loaded onto the stage 210 with the substrate side down (towards the laser output and facing the stationary stage) and the deposited layered side up (towards the debris extraction unit which would be attached to the top side of movable gantry 240 and facing away from the stationary stage). The workpiece 220 is received onto an array of support rollers 260, although other bearing- or translation-type objects can also be used to receive and translate the workpiece as known in the art. In this example, the array of support rollers 260 all point in a single direction, along the direction of the long axis of the substrate, such that the workpiece 220 can be loaded and unloaded in a longitudinal direction relative to the laser assembly. Because the laser output must reach the workpiece from the substrate side during the scribing process, the array of support rollers 260 must collapse and expand to provide the movable gantry 240 room to move across the workpiece in the longitudinal direction and allow the laser output to reach the workpiece. Of course the array of support rollers 260 can be moved back into their “loading” position to allow unloading of the workpiece 220. During the laser scribing process, when the array of support rollers 260 has collapsed and expanded to allow the movable gantry 240 the room to move across the workpiece in the longitudinal direction, air bearings (as shown in FIG. 3) may be used to support the workpiece, while clamps may be used to hold the workpiece at the edges of the workpiece.

In one embodiment, the laser scribing device 200 may be constructed of three parts, which can be disassembled, packed in ISO (International Organization for Standardization) containers, and reassembled on site. This allows for fast installation and reassembly of the laser scribing device 200, as well as the capability to be shipped using conventional transport methods.

FIG. 3 illustrates an end view 300 of a portion of the example device, illustrating part of an optical system used to laser scribe the deposited layers of the workpiece. This part of the optical system can be attached to the movable gantry 240 and it comprises at least one mirror 320 and a focusing element 330. It is mounted on a laterally moveable assembly which allows this part of the optical system to translate back and forth laterally on the gantry with respect to the workpiece. In this example, mirror 320 directs laser beam 310 to workpiece 340 via focusing element 330. This optical system may include other elements, such as lenses and other optical elements, needed to further focus or otherwise adjust aspects of the laser. Elements and approaches for adjusting laser output, such as an attenuating element to attenuate output pulses, a shutter to control the shape of each pulse, and an auto-focusing element to focus the pulses onto the workpiece, are well known in the art and will not be discussed herein in detail.

Laser beam 310 is generated by any appropriate laser device, such as a pulsed solid-state laser, operable to ablate, scribe, or otherwise affect at least one layer of the workpiece. As discussed above, the laser 230 is positioned to the side of the planar stage 210. Optical elements direct the laser output to below the workpiece such that the laser output passes through the substrate (i.e., glass) and ablates or otherwise causes material to be removed from a layer on the opposite (i.e., top) side of the glass. Other arrangements can be used as appropriate, and directions are given as examples and should not be interpreted as requirements unless otherwise stated as such. Thus, the laser beam 310 in this example comes from a position below the workpiece, with the mirror 320 directing it to proceed upward in order to ablate material from the top surface of the workpiece, such as to form scribe lines in the manufacture of a solar cell device. In another embodiment, the mirror 320 or some other optical elements may also provide some lateral motion to the laser output on the workpiece 340. In yet another embodiment, the mirror 320 or some other optical elements may also provide some lateral and longitudinal motion to the laser output on the workpiece 340.

An advantage of mounting part of the optical system on a movable gantry 240 is that, by laterally translating the optical system and longitudinally translating the gantry, substantially any position on the workpiece can be reached by the laser device, allowing any pattern to be scribed on the workpiece without need to rotate the workpiece.

When the pattern to be etched will contain multiple substantially parallel features, such as scribe lines for a solar panel including an array of cells, throughput can be increased by utilizing multiple lasers and optical assemblies on a movable gantry 240. In one embodiment, each of the laser assemblies can scribe respective points on the surface at the same time, thereby reducing the number of passes and/or amount of time needed to scribe a pattern on the workpiece. Increasing the number of laser assemblies on the gantry also reduces the amount of movement needed for the gantry, as four laser assemblies would each only have to each cover about ¼ of the surface area of the workpiece, where a single laser would have to be able to move laterally across the entire workpiece.

Each laser is able to form a “spot” on the workpiece, which is essentially the effective area for ablation. The system can be controlled so that each pulse of a laser is directed to a different spot or location on the workpiece. In one example, a spot size on the workpiece is on the order of tens of microns, although various other dimensions are possible. Careful calibration and control allow for precise positioning of the output of each laser, and imaging apparatus as discussed above can be used to verify the positioning of the ablation spots. Optical elements in the laser assemblies also can be adjusted to control an effective area or spot size of the laser pulses on the workpiece, which in one example vary from about 25 microns to about 100 microns in diameter.

FIG. 3's end view 300 of the example device also displays a debris extraction unit 350 and air bearings 360. The laser scribed lines are formed on the deposited layer (i.e., top) side of the workpiece 340, by removing material from the deposited layers. This removal or ablation is achieved by concentrating a large amount of energy into a very short duration laser pulse and removing the material in an explosive plume that contains debris. This debris is then removed using a debris extraction unit 350.

In this example, spring loaded air bearings 360 support and hold a workpiece 340 both from the top and the bottom. Air bearings 360 have the advantage of being a non contact support. The workpiece 340 is kept at a constant distance above the optical elements (i.e., a mirror 320 and a focusing element 330) by having both the top and bottom air bearings push against the workpiece 340. This allows the laser beam 310 to remain focused at the deposited layer (i.e., top) side of the workpiece 340, where the laser ablation is taking place. In another embodiment, there are no top air bearings, so only bottom air bearings are used to support and hold the workpiece 340. In that case, gravity provides the downward force to keep the workpiece 340 at a constant distance above the optical elements (i.e., a mirror 320 and a focusing element 330). It may be difficult to maintain focus at the deposited layer (i.e., top) side of the workpiece 340 due to variations in its distance from the optical elements. This may be the result of variations in the substrate thicknesses and/or the sagging or bowing down of the substrate near the edge due to weight. In one embodiment, this problem is solved by the use of optical elements or optical element configurations that provide a greater depth of field. In this way, the laser beam 310 will remain in focus even if the position of the deposited layer (i.e., top) side of the workpiece 340 is changing.

FIG. 4 illustrates that each scribe line (e.g. 410 and 430) may be formed by ablating material at each of a sequence of locations along the scribe pattern during movement of the laser output, forming a line of overlapping spots. The spots overlap by an amount, such as 25% by area, that ensures proper region isolation in a layer, or between parts of a cell, while minimizing the number of spots that must be formed in order to ensure acceptable throughput. Various methods of calibrating scribing devices are known, which can provide a level of control of the positioning of the spots on the workpiece.

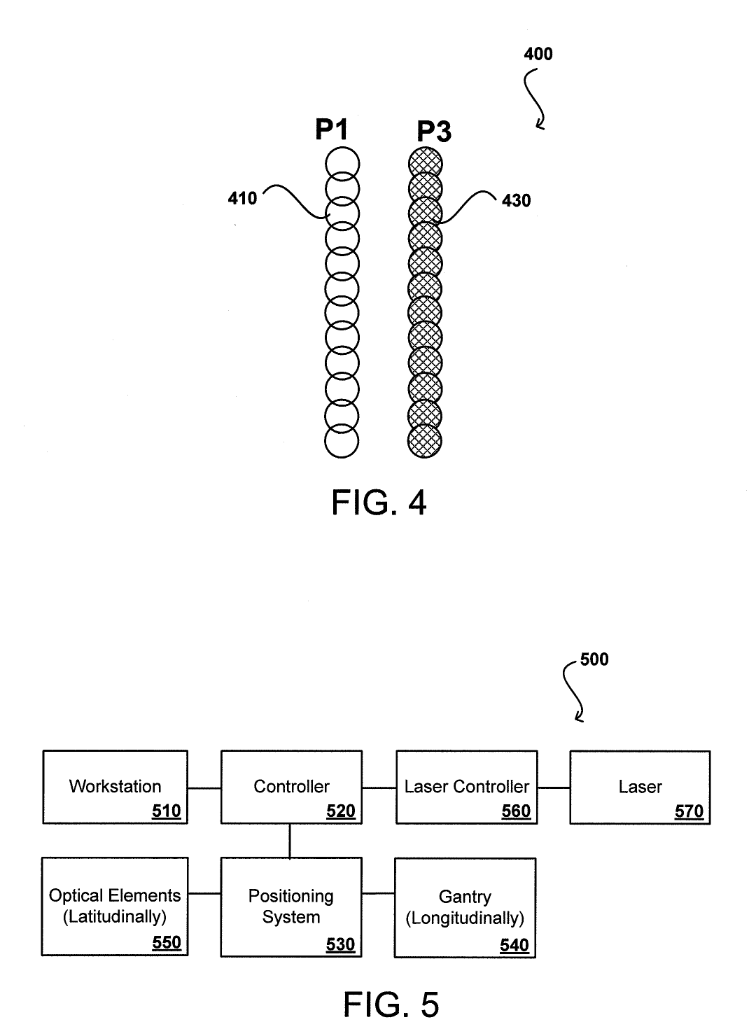

FIG. 5 illustrates a basic control architecture that can be used with systems such as those shown in FIGS. 2-3, although many variations and different elements can be used as would be apparent to one of ordinary skill in the art in light of the teachings and suggestions contained herein. In this design, a workstation 510 works through a system controller 520, such as by using an Ethernet connection, to work with at least one positioning mechanism 530 (or other such device) for driving the gantry 540 longitudinally and the optical elements 550 latitudinally (or laterally). The gantry and the optical elements typically will utilize different motors or drives, and will receive different control signals as the timing and movements will be different for the respective devices. Drive mechanisms for devices such as gantries and optical elements, as well as control mechanisms for these drive mechanisms, are well known in the art and will not be discussed herein in detail. The controller 520 also communicates with a laser controller 560 to control the firing of each appropriate laser 570. The system controller 520 in one example receives an instruction or request from the workstation, and coordinates and synchronizes the signals driving the gantry, optical elements, and lasers, in order to ensure proper positioning of the gantry and optical elements, and firing of the laser(s), in order to scribe the desired pattern. In another example, a computer program product embedded in a computer-readable medium includes instructions for performing the laser scribing method described herein.

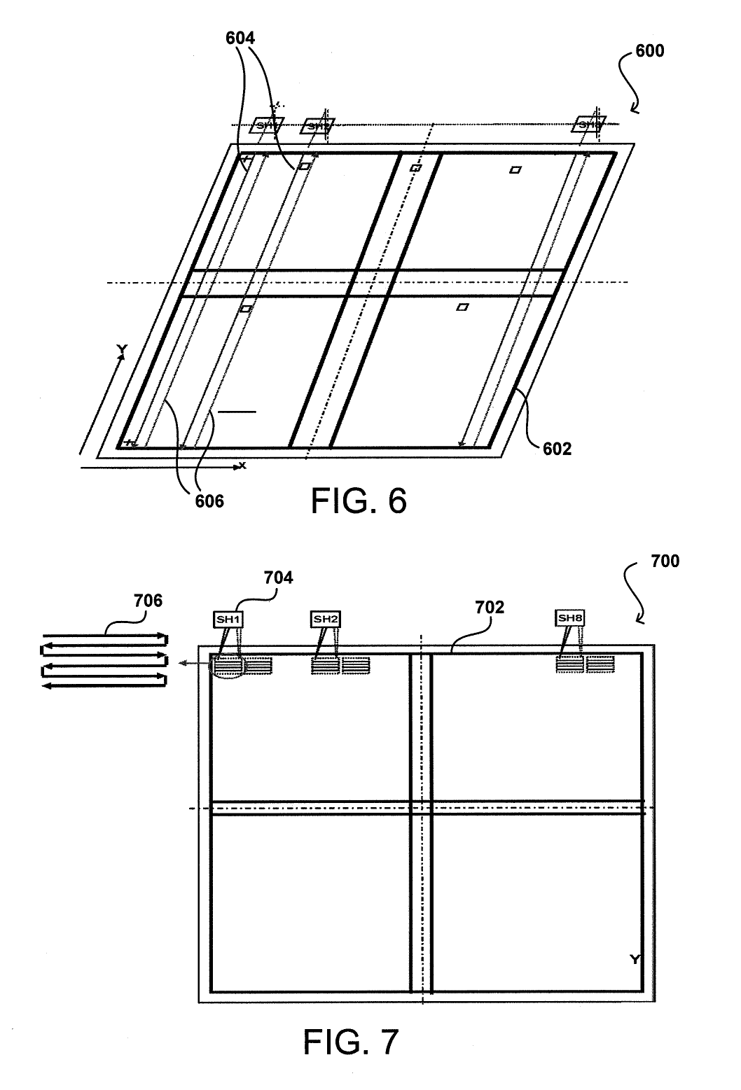

FIG. 6 illustrates an approach 600 for scanning a series of longitudinal scribe lines on a workpiece 602 that can be used with a longitudinal gantry laser scribing device as discussed herein. As shown, the gantry in this example is moved continually in a first longitudinal direction, wherein each laser output is able to form a scribe line 604 moving “down” the substrate. In this example, when the workpiece reaches one longitudinal end of movement, the optical elements are translated laterally to adjust the positions of the laser outputs relative to the workpiece. The gantry is then moved in the opposite longitudinal direction, such that each laser output forms a scribe line 606 going “up” the workpiece (directions used for describing the figure only), with the spacing between the “down” and “up” scribes being controlled by the lateral movement of the optical elements. The laser repetition rate can be matched to the longitudinal gantry translation speed, with a necessary region of overlap between scribe positions for edge isolation. At the end of a scribing pass, the gantry decelerates, stops, and re-accelerates in the opposite direction after latitudinal translation of the optical elements. In this case, the optical elements are adjusted according to the required pitch so that the scribe lines are laid down at the required positions on the glass workpiece. As an example, three sets of longitudinal scribe lines (i.e., SH1, SH2, SH8) are shown, representing the scribing results of three separate laser outputs. Many other scribe strategies using combinations of longitudinal gantry movement and latitudinal optical elements movement can be supported as would be apparent to one of ordinary skill in the art in light of the teachings and suggestions contained herein.

FIG. 7 illustrates an approach 700 for scanning a series of latitudinal (or lateral) scribe lines on a workpiece 702. As discussed above, the optical elements can be moved laterally to adjust the position of each laser output relative to the workpiece. By moving the optical elements back and forth at each of a series of longitudinal positions, as shown in the figure, each laser output can form a serpentine pattern 704 on the workpiece. 706 is an enlarged view of the serpentine pattern 704, displayed to show more clearly the details. As an example, three sets of latitudinal scribe lines (i.e., SH1, SH2, SH8) are shown, representing the scribing results of three separate laser outputs. As shown, the optical elements can cause each beam to move in one latitudinal direction at one longitudinal position of the gantry, then in another latitudinal direction at another longitudinal position of the gantry. By ensuring that the lines from each laser meet, a full latitudinal scribe line can be formed at each position of the workpiece. Otherwise, if minimal movement of the optical elements is desired to minimize drift errors, for example, the optical elements may need to make several passes in order to form the latitudinal lines, as shown in FIG. 7.

In one embodiment, scribe placement accuracy is guaranteed by synchronizing the stage encoder pulses to the laser and spot placement triggers. The system can ensure that the workpiece is in the proper position, and the lasers positioned accordingly, before the appropriate laser pulses are generated. Synchronization of all these triggers is simplified by using the single system controller to drive all these triggers from a common source. Various alignment procedures can be followed for ensuring alignment of the scribes in the resultant workpiece after scribing. Once aligned, the system can scribe any appropriate patterns on a workpiece, including fiducial marks and bar codes in addition to cell delineation lines and trim lines.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A system for scribing a workpiece, comprising:
a stationary stage operable to support the workpiece;
a laser generating output able to remove material from at least a portion of the workpiece; and
a translatable scanning device operable to control a position of the output from the laser,
wherein substantially any pattern is able to be scribed on the workpiece without moving the workpiece.

2. A system according to claim 1, wherein:
the scanning device includes:
an optical system operable to direct output from the laser to the workpiece; and
a gantry holding at least a portion of the optical system.

3. A system according to claim 2, wherein:
the gantry can be moved longitudinally and the portion of the optical system attached to the gantry can be moved laterally; and
output from a laser is able to be directed to substantially any position on the workpiece without moving the workpiece.

4. A system according to claim 3, wherein:
the gantry is further operable to concurrently direct additional laser outputs laterally in order to control positions of the laser outputs relative to the workpiece, such that the output from each laser is able to reach a portion of the workpiece and the combined output from all the lasers is able to reach substantially any position on the workpiece.

5. A system according to claim 1, wherein:
the workpiece includes a substrate and at least one layer used for forming a solar cell, the laser able to remove material from the at least one layer.

6. A method of scribing a workpiece, comprising:
directing output from a laser toward a workpiece;
controlling a latitudinal position of the laser output relative to the workpiece by using optical elements on a gantry; and
controlling a longitudinal position of the laser output relative to the workpiece by moving the gantry in order to scribe a determined pattern in at least a portion of the workpiece without moving the workpiece.

7. A computer program product embedded in a computer-readable medium including instructions for performing the method of claim 6.

8. A system according to claim 1, wherein:
the stationary stage comprises air bearings to support the workpiece.

9. A system according to claim 8, wherein:
the air bearings allow the laser generating output to remain focused at the point where the laser generating output removes material from at least a portion of the workpiece.

10. A system according to claim 9, wherein:
the laser output is directed at the workpiece from the side of the workpiece that is facing the stationary stage.

11. A system according to claim 10, further comprising:
movable support rollers on the stationary stage, operable to load and unload the workpiece,
wherein the movable support rollers collapse and expand to allow the laser output to reach the workpiece during the scribing process.

12. A system for aligning a laser for scribing a workpiece, comprising:
a laser device operable to generate output able to remove material from at least a portion of the workpiece to form at least one feature on the workpiece;
a scanning device operable to control a position of the output from the laser relative to the workpiece; and
an imaging device operable to image previously-formed features on the workpiece,
wherein the scanning device is able to use image information from the imaging device to align the position of the output from the laser relative to at least one previously-formed feature on the workpiece.

13. A system according to claim 12, wherein:
the workpiece includes a substrate and at least one layer used for forming a solar cell, the laser able to remove material from the at least one layer.

14. A system according to claim 13, wherein:
the at least one previously-formed feature on the workpiece is a laser scribed line.

15. A system according to claim 14, wherein:
the imaging device is able to align the position of the output from the laser relative to the at least one previously-formed feature on the workpiece by optically observing the previously-formed feature on the workpiece.

16. A system according to claim 12, wherein:
the imaging device is a camera.

17. A system according to claim 16, wherein:
the camera is mounted between the laser and the scanner device so that the center of the camera view and the output of the laser point at substantially the same position on the workpiece.

18. A system according to claim 12, wherein:
the imaging device is included within the scanning device.

19. A system according to claim 1, wherein:
the system is constructed of three parts which can be disassembled, packed in ISO containers and reassembled on site.
